(19) United States
(12) Patent Application Publication
(10) Pub. No.: US 2017/0222287 A1
(43) Pub. Date: Aug. 3, 2017

(54) LITHIUM-AIR BATTERY AND LITHIUM-AIR BATTERY DEVICE

(71) Applicant: DENSO CORPORATION, Kariya-city, Aichi-pref. (JP)

(72) Inventors: Yosuke SUZUKI, Kariya-city (JP); Kenichirou KAMI, Kariya-city (JP); Kazuki HIRATA, Kariya-city (JP)

(21) Appl. No.: 15/500,674

(22) PCT Filed: Oct. 27, 2015
(86) PCT No.: PCT/JP2015/005387

§ 371 Date: Jan. 31, 2017

(30) Foreign Application Priority Data
Oct. 30, 2014 (JP) 2014-221188
Sep. 30, 2015 (JP) 2015-192600

(51) Int. Cl. H01M 12/06; H01M 8/0606; H01M 8/04119

(52) U.S. Cl. CPC H01M 12/06; H01M 8/04126; H01M 8/0606

(57) ABSTRACT

A lithium-air battery includes: an anode that includes an anode material for absorbing and desorbing a lithium ion; a cathode that includes a cathode material with a catalyst for reducing the oxygen using oxygen as a cathode active material; and a solid electrolyte layer that includes a solid electrolyte interposed between the anode and the cathode. At least one of charge and discharge is performed in a presence of vapor-phase water. That is, the reduction of oxygen or an oxide is performed in the presence of the vapor-phase water. With this arrangement, the air battery can exhibit the effect of reducing the overvoltage.

### CROSS REFERENCE TO RELATED APPLICATIONS

This application is based on Japanese Patent Applications No. 2014-221188 filed on Oct. 30, 2014, and No. 2015-192600 filed on Sep. 30, 2015, the disclosures of which are incorporated herein by reference.

### TECHNICAL FIELD

The present disclosure relates to a lithium-air battery and a lithium-air battery device.

### BACKGROUND ART

With the development of portable devices, including personal computers and cellular phones, the demand for batteries as a power source has recently expanded remarkably. To achieve batteries with a larger capacity, lithium-air batteries have been studied that use oxygen in the air as a cathode active material. The lithium-air batteries have high energy densities.

Such lithium-air batteries are reported to exhibit a very large discharge capacity because there is no need to fill a cathode active material.

The lithium-air battery includes, for example, a cathode layer including a conductive material, a catalyst, and a binder; a cathode collector for collecting electricity of the cathode layer; an anode layer made of metal or an alloy; an anode collector for collecting electricity of the anode layer; and an electrolyte interposed between the cathode layer and the anode layer. The lithium-air battery is considered to experience the following charge and discharge reactions:

[During Discharge]
Anode: Li→Li⁺+e⁻
Cathode: 2Li⁺+O₂+2e⁻→Li₂O₂

[During Charge]
Anode: Li⁺+e⁻→Li
Cathode: Li₂O₂→2Li⁺+O₂+2e⁻

An electrolytic solution that dissolves a support electrolytic salt in an organic solvent is conventionally used as an electrolyte for a battery. The electrolytic solution using the organic solvent as a medium exhibits a high ion conductivity.

However, a lithium-air battery using the electrolytic solution requires the installment of a safety device for suppressing a temperature rise due to short circuit to prevent combustion of the organic solvent, as well as the improvement of the structure or material to prevent short circuit. As the organic solvent is volatile, the lithium-air battery, which is configured to take air into the battery and to operate by taking oxygen from the air into the cathode, is considered to have a problem in terms of stability during the long-term operation. That is, in the long-term operation, the lithium-air battery might volatilize the electrolytic solution from the cathode. The volatilization of the electrolytic solution is predicted to increase the resistance of the lithium-air battery, drastically degrading the battery performance.

In contrast, an all-solid-state air battery replacing the electrolytic solution with a solid electrolyte does not use an organic solvent in the battery. The solid electrolyte improves ionic conductivity due to the temperature rise. Thus, the all-solid-state air battery can simplify the safety device for preventing the temperature rise, and is superior in manufacturing cost and productivity. Furthermore, the all-solid-state air battery might not cause the organic solvent to volatilize from the cathode. Accordingly, the degradation in the battery performance due to the volatilization of the organic solvent can be prevented.

Patent Document 1 discloses a lithium-air battery that includes an anode, a cathode including a catalyst for reduction of oxygen and a first solid electrolyte layer, and a second solid electrolyte layer disposed between the anode and the cathode. Furthermore, Patent Document 1 also describes that the first solid electrolyte layer and the second solid electrolyte layer are not physically separated but continued. However, an air electrode needs to have on its surface, an organic electrolytic solution or an aqueous electrolytic solution, and thus cannot prevent the degradation in the performance of the battery due to the volatilization of the electrolytic solution.

To address the problems associated with the volatilization of these electrolytic solutions, batteries not requiring any aqueous solution or electrolyte have also been examined.

The conventional lithium-air battery is known to cause overvoltage during recharge after discharge. The occurrence of the overvoltage leads to the reduction in battery capacity, resulting in a problem of degrading the performance of the lithium-air battery.

### PRIOR ART LITERATURES

### Patent Literature

Patent Literature 1: JP-2011-96586 A

### SUMMARY OF INVENTION

It is an object of the present disclosure to provide a lithium-air battery and a lithium-air battery device that enable charge and discharge with a large amount of current while suppressing the occurrence of overvoltage.

According to a first aspect of the present disclosure, a lithium-air battery includes: an anode that includes an anode material for absorbing and desorbing a lithium ion; a cathode that includes a cathode material with a catalyst for reducing the oxygen using oxygen as a cathode active material; and a solid electrolyte layer that includes a solid electrolyte interposed between the anode and the cathode. At least one of charge and discharge is performed in a presence of vapor-phase water. That is, the reduction of oxygen or an oxide is performed in the presence of the vapor-phase water. With this arrangement, the air battery can exhibit the effect of reducing the overvoltage.

According to a second aspect of the present disclosure, a lithium-air battery includes: an anode that includes an anode material for absorbing and desorbing a lithium ion; a cathode that includes a cathode material with a catalyst for reducing the oxygen using oxygen as a cathode active material; and a solid electrolyte layer that includes a solid electrolyte interposed between the anode and the cathode. A reaction product generated by discharge includes an amorphous phase. That is, the reaction product generated by the discharge includes the amorphous phase, thereby exhibiting the same effects as those of the first air battery described above.

According to a third aspect of the present disclosure, a lithium-air battery includes: an anode that includes an anode material for absorbing and desorbing a lithium ion; a cathode that includes a cathode material with a catalyst for reducing the oxygen using oxygen as a cathode active material; and a solid electrolyte layer that includes a solid electrolyte interposed between the anode and the cathode. A reaction product generated by discharge includes a hydrogen atom. That is, the reaction product generated by the discharge includes hydrogen atoms, thereby exhibiting the same effects as those of the first and second air batteries described above. Note that the hydrogen atom in the reaction product means hydrogen in an atomic state. The hydrogen in the atomic state includes hydrogen in a proton (an ionic) state.

According to a fourth aspect of the present disclosure, a lithium-air battery device includes: a lithium-air battery cell including an anode that includes an anode material for absorbing and desorbing a lithium ion, a cathode that includes a cathode material with a catalyst for reducing the oxygen using oxygen as a cathode active material, and a solid electrolyte layer that includes a solid electrolyte interposed between the anode and the cathode; and a water supply unit that supplies vapor-phase water to the cathode of the lithium-air battery cell. The lithium-air battery device can exhibit the same effects as those of the first to third air batteries in the present invention described above.

### BRIEF DESCRIPTION OF DRAWINGS

The above and other objects, features and advantages of the present disclosure will become more apparent from the following detailed description made with reference to the accompanying drawings. In the drawings:

FIG. 1 is a diagram showing the configuration of an air battery system in a first embodiment;

FIG. 2 is a schematic configuration diagram showing the structure of an air battery cell in the first embodiment;

FIG. 3 is a cross-sectional view showing the structure of an air battery cell in a test example;

FIG. 4 shows a profile of changes in discharge and charge voltages of an air battery system in the test example;

FIG. 5 shows a profile of changes in discharge and charge voltages of an air battery system in a comparative test example;

FIG. 6 is a diagram showing changes in discharge and charge voltages of the air battery system in the test example;

FIG. 7 is a diagram showing changes in discharge and charge voltages of the air battery system in the comparative test example;

FIG. 8 is an SEM image of a solid electrolyte layer after discharge of the air battery cell in the test example;

FIG. 9 is a graph showing the result of Raman spectroscopic analysis on the solid electrolyte layer after discharge of the air battery cell in the test example;

FIG. 10 is XRD patterns of the solid electrolyte layer after discharge of the air battery cell in the test example;

FIG. 11 is the result of SIMS analysis on the solid electrolyte layer after discharge of the air battery cell in the test example;

FIG. 12 is a schematic configuration diagram showing the structure of an air battery system in a second embodiment; and

FIG. 13 is a schematic configuration diagram showing the structure of an air battery system in a third embodiment.

### EMBODIMENTS FOR CARRYING OUT INVENTION

In the following, a lithium-air battery and a lithium-air battery device according to embodiments of the present disclosure will be specifically described.

### First Embodiment

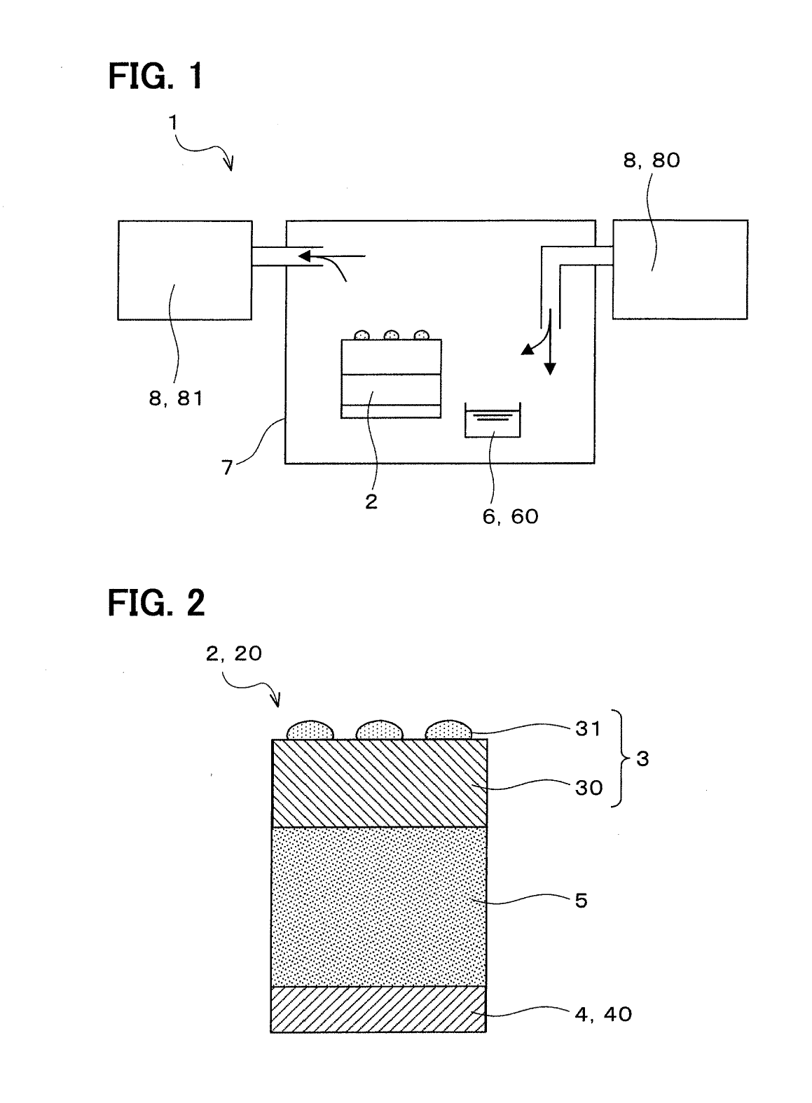

As illustrated in FIG. 1, a lithium-air battery system 1 in this embodiment includes a lithium-air battery cell 2 and a humidification device 6. The air battery system 1 corresponds to an air battery device according to the present disclosure. The air battery cell 2 corresponds to first to third air batteries according to the present disclosure.

(Air Battery Cell 2)

As shown in FIG. 2, the air battery cell 2 in this embodiment includes, as dischargeable and rechargeable elements, a cathode 3, an anode 4, and a solid electrolyte layer 5. Here, in the air battery, the cathode 3 is also referred to as an air electrode.

The cathode 3 includes a cathode material that uses oxygen as an active material and includes a catalyst for reducing oxygen. The cathode 3 is equipped with an air introducing device for introducing thereinto oxygen (or gas including oxygen) as the active material to promote a battery reaction.

The anode 4 includes an anode material capable of absorbing and desorbing a lithium ion.

The solid electrolyte layer 5 is a layer that includes a solid electrolyte interposed between the anode 4 and the cathode 3. The solid electrolyte layer 5 functions as a transfer route for transferring lithium ions between the cathode 3 and the anode 4.

As shown in FIG. 2, the air battery cell 2 in this embodiment can be formed of a stacked body in which the cathode 3, the anode 4, and the solid electrolyte layer 5 are stacked on each other. Note that the air battery cell 2 may not be formed of the stacked body.

The air battery cell 2 in this embodiment is not specifically limited and has any outer shape that can bring gas including oxygen into contact with the cathode 3. An example of the shape (structure) that can bring the gas into contact with the cathode 3 can be the shape with a gas intake port. The battery cell can be of any desired outer shape, including a cylindrical shape, a rectangular shape, a button shape, a coin shape, or a flat shape.

The air battery cell 2 in this embodiment may be either a primary cell or a secondary cell. The air battery cell is preferably the dischargeable and rechargeable secondary cell.

(Solid Electrolyte Layer 5)

The solid electrolyte layer 5 is interposed between the cathode 3 and the anode 4 and formed of a solid electrolyte capable of transferring lithium ions. In particular, the solid electrolyte preferably uses a material that has high conductivity of lithium ions with no electron conductivity. The solid electrolyte preferably uses an inorganic material (inorganic solid electrolyte) that can be sintered at a high temperature in the air atmosphere.

The solid electrolyte layer 5 may not only be a single layer, but also be a multi-layer including a semi-solid electrolyte layer 50 to be described later.

The inorganic solid electrolyte may be any one of crystals, glass, a mixture thereof, and a complex thereof. The inorganic solid electrolyte may be any material that does not drastically degrade its performance due to contact with water vapor, and is more preferably an oxide-based inorganic solid electrolyte suitable for the high-temperature sintering, while exhibiting excellent stability under the air atmosphere.

Such an oxide-based inorganic solid electrolyte preferably includes at least one inorganic solid electrolytic material having a crystal structure selected from the group consisting of a perovskite-type, a NASICON-type, a LISICON-type, a thio-LISICON type, a γ-Li₃PO₄-type, a garnet-type, and a LIPON-type crystal structures.

Examples of the perovskite-type oxide can include oxides (Li—La—Ti—O based perovskite type oxides), represented by LiₓLa₁₋ₓTiO₃ and the like.

Examples of the NASICON-type oxide can include oxides represented by LiₐX_{b}Y_{c}P_{d}Oₑ (where X is at least one element selected from the group consisting of B, Al, Ga, In, C, Si, Ge, Sn, Sb, and Se; Y is at least one element selected from the group consisting of Ti, Zr, Ge, In, Ga, Sn, and Al; and the following relationships are satisfied: 0.5<a<5.0, 0≦b<2.98, 0.5≦c<3.0, 0.02<d≦3.0, 2.0<b+d<4.0, and 3.0<e≦12.0.) In particular, in the above-mentioned formula, the NASICON-type oxide is preferably an oxide (Li—Al—Ti—P—O based NASICON-type oxide) where X=Al, and Y=Ti, or an oxide (Li—Al—Ge—Ti—O based NASICON-type oxide) where either X=Al and Y=Ge, or X=Ge and Y=Al. Furthermore, Li_{1.3}Al_{0.3}Ti_{1.7}(PO₄)₃ (LATP) as the Li—Al—Ti—P—O based NASICON-type oxide is more preferable.

Examples of the LISICON-type oxide, the thio-LISICON-type oxide, or the γ-Li₃PO₄-type oxide can include Li₄XO₄—Li₃YO₄ (where X is at least one element selected from Si, Ge, and Ti; and Y is at least one element selected from P, As, and V), Li₄XO₄—Li₂AO₄ (where X is at least one element selected from Si, Ge, and Ti; and A is at least one element selected from Mo and S), Li₄XO₄—Li₂ZO₂ (where X is at least one element selected from Si, Ge, and Ti; and Z is at least one element selected from Al, Ga, and Cr), Li₄XO₄—Li₂BXO₄ (where X is at least one element selected from Si, Ge, and Ti; and B is at least one element selected from Ca and Zn), and Li₃DO₃—Li₃YO₄ (where D is B, and Y is at least one element selected from P, As, and V.) In particular, Li_{3.25}Ge_{0.25}P_{0.75}S₄, Li₄SiO₄—Li₃PO₄, and Li₃BO₃—Li₃PO₄, etc., are preferable.

Examples of the garnet-type oxide can include oxides represented by Li₃₊ₓA_{y}G_{z}M₂₋ᵥBᵥO₁₂. Here, A, G, M, and B are metal cations. A is preferably a cation of an alkali earth metal, such as Ca, Sr, Ba, and Mg, or a cation of a transition metal, such as Zn. G is preferably a cation of a transition metal, such as La, Y, Pr, Nd, Sm, Lu, and Eu. M can be a cation of a transition metal, such as Zr, Nb, Ta, Bi, Te, and Sb. Among them, Zr is the most preferable.

B is preferably, for example, In. X preferably satisfies the range of 0≦x≦5, and more preferably satisfies the range of 4≦x≦5. Y preferably satisfies the range of 0≦y≦3, and more preferably satisfies the range of 0≦y≦2. Z preferably satisfies the range of 0≦z≦3, and more preferably satisfies the range of 1≦z≦3. V preferably satisfies the range of 0≦v≦2, and more preferably satisfies the range of 0≦v≦1. Note that O may be partially or completely replaced with a divalent anion and/or trivalent anion, for example, N³⁻. The garnet-type oxide is preferably a Li—La—Zr—O-based oxide, such as Li₇La₃Zr₂O₁₂ (LLZ).

Examples of the LiPON-based oxide can include Li_{2.88}PO_{3.73}N_{0.14}, and Li_{3.0}PO_{2.0}N_{1.2}.

The solid electrolyte layer 5 may further include an electrolyte layer made of semi-solid (hereinafter referred to as the semi-solid electrolyte layer 50). The semi-solid electrolyte layer 50 is a deformable, gel electrolyte layer (electrolyte layer that is elastically deformable), and can be, for example, a layer made of a non-aqueous electrolyte. The non-aqueous electrolyte forming the semi-solid electrolyte layer 50 may be disposed between the solid electrolyte layer 5 and the anode 4 while an insulating porous member is impregnated with the non-aqueous electrolyte. The insulating porous member is made of a porous film of polyethylene, polypropylene, etc., a non-woven fabric, such as a resin non-woven fabric or a glass non-woven fabric, or the like

Note that the non-aqueous electrolyte can be used in the form of gel by adding a polymer, such as polyethylene oxide (PEO), polyacrylonitrile (PAN), or polymethyl methacrylate (PMMA). In terms of ion conductivity of the non-aqueous electrolyte, the non-aqueous electrolyte is preferably used without taking the form of gel.

(Cathode 3)

The cathode 3 is formed of a cathode material including a catalyst 31, a solid electrolyte 30, and a conductive material, and a cathode collector (not shown). The cathode material includes the solid electrolyte 30 as a base material and holes into which gas (gas including oxygen) can be introduced. The catalyst 31 is disposed on the surface (inner surfaces of holes) of the solid electrolyte 30.

The solid electrolyte 30 can be made by selecting and using any solid electrolyte that can be used for the above-mentioned solid electrolyte layer 5. The solid electrolyte 30 is preferably formed using the same solid electrolyte as that selected for the above-mentioned solid electrolyte layer 5. The solid electrolyte 30 is formed of the same inorganic electrolyte as the solid electrolyte forming the above-mentioned solid electrolyte layer 5, so that the solid electrolyte layer 5 and the cathode material (cathode 3) can be bonded together by the same solid electrolyte, which can provide the air battery with a low contact resistance that is easily manufactured.

The catalyst 31 promotes the reaction of oxygen (reduction reaction) as the cathode active material at the cathode 3. Examples of the catalyst can include one or more elements selected from the group consisting of silver, palladium, gold, platinum, aluminum, nickel, titanium, platinum, iridium oxides, ruthenium oxides, manganese oxides, cobalt oxides, nickel oxides, iron oxides, copper oxides, and metal phthalocyanines.

Oxygen (oxygen included in the atmosphere) existing around the air battery cell 2 (cathode 3) is used as the oxygen of the cathode active material.

The conductive material is used as needed. The conductive material is not particularly limited as long as it has electrical conductivity. The conductive material is required to have the necessary stability under the atmosphere within the air battery cell 2. The conductive material used to be integrated with the cathode 3 or anode 4 is preferably material suitable for sintering. For example, metal or an alloy having high oxidation resistance is preferably used as the conductive material. Regarding the metal or alloy having the high oxidation resistance, the metal is preferably silver, palladium, gold, platinum, copper, aluminum, and nickel. The alloy is preferably an alloy of two or more metals selected from silver, palladium, gold, platinum, aluminum, nickel, and titanium. Alternatively, the conductive material may be made of oxides of these metals or alloys.

The cathode collector needs only to be a member that has the electrical conductivity. The cathode 3 requires the device for introducing gas including oxygen into the cathode material, and thus the cathode collector is preferably formed to be permeable to oxygen. For example, the cathode collector is preferably porous material made of metal, such as stainless steel, nickel, aluminum, copper, etc., a mesh, a punching metal, or the like. When using the porous material or the like, the conductive material, the catalyst, and the like may be preferably filled in holes thereof.

(Anode 4)

The anode 4 includes an anode material 40 including an anode active material capable of absorbing and desorbing a lithium ion, and an anode collector (not shown). The anode material 40 can include, in addition to the anode active material, a solid electrolyte and a conductive material. The anode collector can take the form of mesh, punched metal, foam metal, plate, foil, and the like that is made of copper, nickel, etc. The anode collector can also serve as a battery casing.

The anode active material is one or more materials selected from the group consisting of lithium metal, a lithium alloy, a metal material capable of absorbing and desorbing lithium, an alloy material capable of absorbing and desorbing lithium (which includes not only an alloy consisting of only metals, but also an alloy including metal and metalloid elements; its microstructure includes a solid solution, a eutectic (eutectic mixture), an intermetallic compound, or a mixture of two or more thereof), and a compound capable of absorbing and desorbing lithium. Note that the cathode portion, the solid electrolyte portion, and the anode portion are integrally formed by sintering as described later, and thus the anode active material is preferably made of material suitable for the sintering. When using Li metal as the anode active material, the Li metal can be introduced by being inserted or electrochemically precipitated into a Li-metal dissolved precipitation portion formed in the anode.

Examples of metal elements and metalloid elements that form the metal material and alloy material for the anode active material can include tin (Sn), lead (Pb), aluminum (Al), indium (In), silicon (Si), zinc (Zn), antimony (Sb), bismuth (Bi), cadmium (Cd), magnesium (Mg), boron (B), gallium (Ga), germanium (Ge), arsenic (As), silver (Ag), zirconium (Zr), yttrium (Y), and hafnium (Hf). The alloy material or compound thereof can be represented by a chemical formula Ma_{f}Mb_{g}Liₕ or a chemical formula MaₛMcₜMdᵤ. In these chemical formulas, Ma represents at least one of metal elements and metalloid elements capable of forming an alloy with lithium; Mb represents at least one of metal elements and metalloid elements other than lithium and Ma; Mc represents at least one of non-metal elements; and Md represents at least one of metal elements and metalloid elements other than Ma. The following formulas are satisfied: f>0, g≧0, h≧0, s>0, t>0, and u≧0.

Among them, the anode material is preferably an elemental substance, alloy, or compound of a Group 4B metal element or a metalloid element in a short-period form of the periodic table, and more preferably silicon (Si) or tin (Sn), or an alloy or compound thereof. These materials may be crystalline or amorphous.

Further, the material as the anode active material capable of absorbing and desorbing lithium can be an oxide, a sulfide, or other metal compounds, including a lithium nitride, such as LiN₃. Examples of the oxide can include MnO₂, V₂O₅, V₆O₁₃, NiS, and MoS. Other examples of the oxide capable of absorbing and desorbing lithium at a relatively lower potential can include iron oxide, ruthenium oxide, molybdenum oxide, tungsten oxide, titanium oxide, and tin oxide. Examples of the sulfide can include NiS and MoS.

The solid electrolyte included in the anode material is used as needed. The solid electrolyte included in the anode material uses the same solid electrolyte as that used in the solid electrolyte layer 5.

The solid electrolyte included in the anode material can be selected from solid electrolytes that can be used for the above-mentioned solid electrolyte layer 5. The solid electrolyte included in the anode material preferably uses the same inorganic solid electrolyte as the solid electrolyte selected for the above-mentioned solid electrolyte layer 5. The solid electrolyte included in the anode material is formed of the same electrolyte as the solid electrolyte forming the above-mentioned solid electrolyte layer 5, so that the solid electrolyte layer 5 and the anode material 40 (anode 4) can be bonded together by the same solid electrolyte, which can provide the air battery with low contact resistance that is easily manufactured.

When the cathode 3 (cathode material) and the anode 4 (anode material 40) include the solid electrolyte, the solid electrolyte included in both the cathode and anode is most preferably the same inorganic solid electrolyte as the solid electrolyte selected for the above-mentioned solid electrolyte layer 5.

The conductive material of the anode material is used as needed. The conductive material can use the same as that exemplified in the paragraph regarding the cathode 3.

The anode collector may be any member that has the electrical conductivity. Examples of the material for the anode collector can include copper, stainless, and nickel. The anode collector can have the shape of, for example, a foil, a plate, a mesh (grid), and the like.

(Humidification Device 6)

The humidification device 6 humidifies gas including oxygen to be introduced into the cathode 3 of the air battery cell 2. The humidification device 6 supplies vapor-phase water to the cathode 3. The humidification device 6 promotes the reduction of oxygen to be introduced into the cathode 3 in the presence of the vapor-phase water. The humidification device 6 corresponds to a water supply portion and a humidifying device.

The humidification device 6 is not particularly limited and has any structure that can supply the vapor-phase water to the surroundings of the air battery cell 2 (cathode 3). In this embodiment, as shown in FIG. 1, the humidification device 6 is configured of a water reservoir 60 disposed around the air battery cell 2 within a case 7.

In the humidification of the gas including oxygen to be introduced into the cathode 3 by the humidification device 6, the humidity of the gas is not limited. The humidity of the gas needs only to be higher than 0% (not to be 0%).

Note that the temperature of the cathode 3 is preferably equal to or higher than a dew point of water (moisture) included in the gas.

(Other Structures)

As illustrated in FIG. 1, the air battery system 1 in this embodiment includes the case 7 for accommodating therein the air battery cell 2 and the humidification device 6, 60, and an atmosphere adjustment device 8 for adjusting the atmosphere within the case 7. The atmosphere adjustment device 8 adjusts the gas atmosphere including oxygen. Other necessary members for the structure of the air battery system (for example, conductive wires and electrode terminals connected to the electrodes 3 and 4 of the air battery cell 2) are not shown but provided in the air battery system.

The case 7 forms an enclosed space that is capable of housing the air battery cell 2 therein. The case 7 is not limited to a specific structure. For example, a chamber can be used.

The atmosphere adjustment device 8 adjusts the atmosphere within the case 7. The adjustment of the atmosphere is performed by adjusting gas to be supplied to the case 7 as well as gas to be discharged from the case 7. That is, the atmosphere adjustment device 8 is configured of a gas supply device 80 for supplying gas into the case 7 and a gas discharge device 81 for discharging gas from the case 7.

The gas supply device 80 is configured of a device capable of controlling the type (composition) and inflow amount of gas to be supplied to the case 7. For example, such a device can include a gas cylinder, a pipe that communicates the gas cylinder with the inside of the case 7, and a valve that controls the flow rate of gas flowing through the pipe.

Gas supplied by the gas supply device 80 is not particularly limited, but is any gas that includes oxygen. For example, examples of such gas can include the air and gas such as pure oxygen gas.

The gas discharge device 81 is configured of a device capable of controlling the discharge amount of gas to be discharged from the case 7. For example, such a device can include a pipe that communicates the inside of the case 7 with the outside, and a valve that controls the flow rate of gas flowing through the pipe.

The atmosphere adjustment device 8 may have a control unit that controls the gas supply device 80 and the gas discharge device 81.

### Test Example

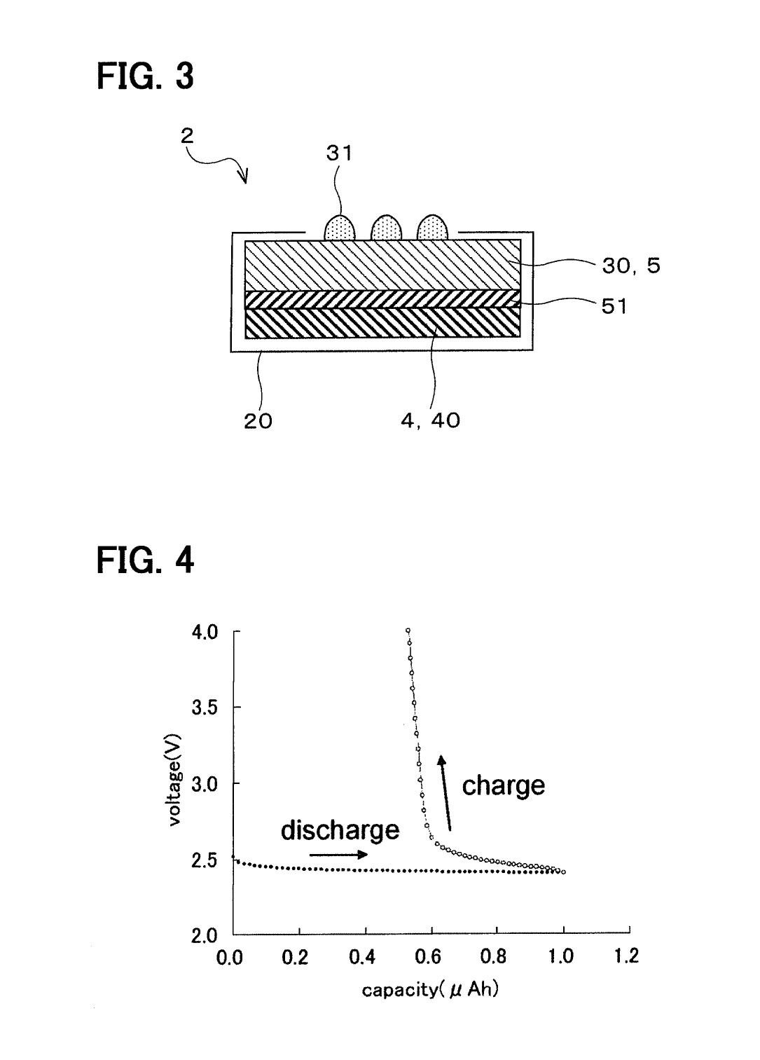

The air battery system 1 in the first embodiment will be specifically described by using a test example. FIG. 3 illustrates the structure of an air battery cell in the test example.

In the air battery cell 2 in the test example, the cathode 3 (solid electrolyte 30 thereof) and the solid electrolyte layer 5 were formed integrally with each other. The anode 4 was disposed to be abutted against a part of the solid electrolyte layer 5 with no cathode 3 formed thereat (part thereof opposed to the cathode 3) via the semi-solid electrolyte layer 50. Such a stacked body was accommodated in an outer casing body 20 made of laminate films.

Specifically, Pt was sputtered on the entire surface of a range of 10 mm×10 mm of a LATP (with Φ19 mm (in diameter) and t=0.15 mm (in thickness), manufactured by OHARA Inc, trade name: LICGC) as the inorganic solid electrolyte, followed by patterning through photolithography, whereby the cathode 3 and the solid electrolyte layer 5 were integrally fabricated.

To pattern the catalyst 31, a mask may be used during the sputtering.

The catalyst 31 made of Pt was provided on the inorganic solid electrolyte 30 in a Pt thickness of 50 nm and in lines with a spacing of 3 to 100 μm.

Together with this, a tab (not shown) serving as a collector was provided in part of the catalyst 31. The tab was fabricated on the solid electrolyte 30 by sputtering Pt in the same way as the catalyst 31. The catalyst 31 and the tab were electrically connected to each other.

The anode material 40 (anode active material) used lithium metal.

The outer casing body 20 was formed of two laminate films. The laminate film had a size of 40 mm×40 mm. One laminate film was used as a cathode-side laminate film and had a hole of Φ14.5 mm formed therein to introduce oxygen into Pt as the catalyst 31. The other laminate film was used as an anode-side laminate film and had no hole. The hole in the cathode-side laminate film was sealed by seal films (not shown) from its outer side and inner side. A nickel lead wire (not shown) serving as an anode terminal was attached to the anode-side laminate film.

Within a glove box in a dry inert atmosphere, the LATP with Pt sputtered thereon, polyethylene oxide (PEO), and lithium metal were stacked in this order to form a stacked body. Then, the cathode-side and anode-side laminate films were placed to sandwich the stacked body between these laminate films. When sandwiching the stacked body between the cathode-side and anode-side laminate films, the stacked body and the films were disposed such that the catalyst layer appeared from the hole in the cathode-side laminate film, and that lithium metal was in contact with the nickel lead wire on the anode-side laminate film. Finally, the inside of the space enclosed by the laminate films were vacuumed and sealed by using a vacuum sealer to fabricate the air battery cell 2. The cell 2 was left to stand at 60° C. using a thermostat bath over one night.

Thereafter, the seal film was removed to expose the whole catalyst layer from the hole in the cathode-side laminate film. Then, a tab as part of the catalyst layer and a nickel lead wire were placed to overlap each other, which were bonded together with a silver paste to thereby form a cathode terminal.

In the way above, the air battery cell 2 in the test example was obtained.

The manufactured air battery cell 2 was accommodated in the case 7.

The water reservoir 60 was put in the case 7, and the gas supply device 80 and the gas discharge device 81 were used to bring the inside of the case 7 into the pure oxygen atmosphere, followed by closing the gas supply device 80 and the gas discharge device 81, thus hermetically sealing the case 7. Note that the pure oxygen atmosphere in the case 7 included water evaporated from the water reservoir 60. Subsequently, the case 7 was held at 60° C. At this time, the humidity of the case 7 was 100%.

In the way above, the air battery system 1 in the test example was obtained.

In a comparative test example, an air battery system including a molecular sieve (dehumidifying agent) in place of water in the water reservoir 60 was also manufactured.

(Evaluation)

To evaluate the respective air battery systems 1 in the test example and the comparative test example, the discharge and charge test were carried out on the respective air battery systems 1.

(Discharge and Charge Test)

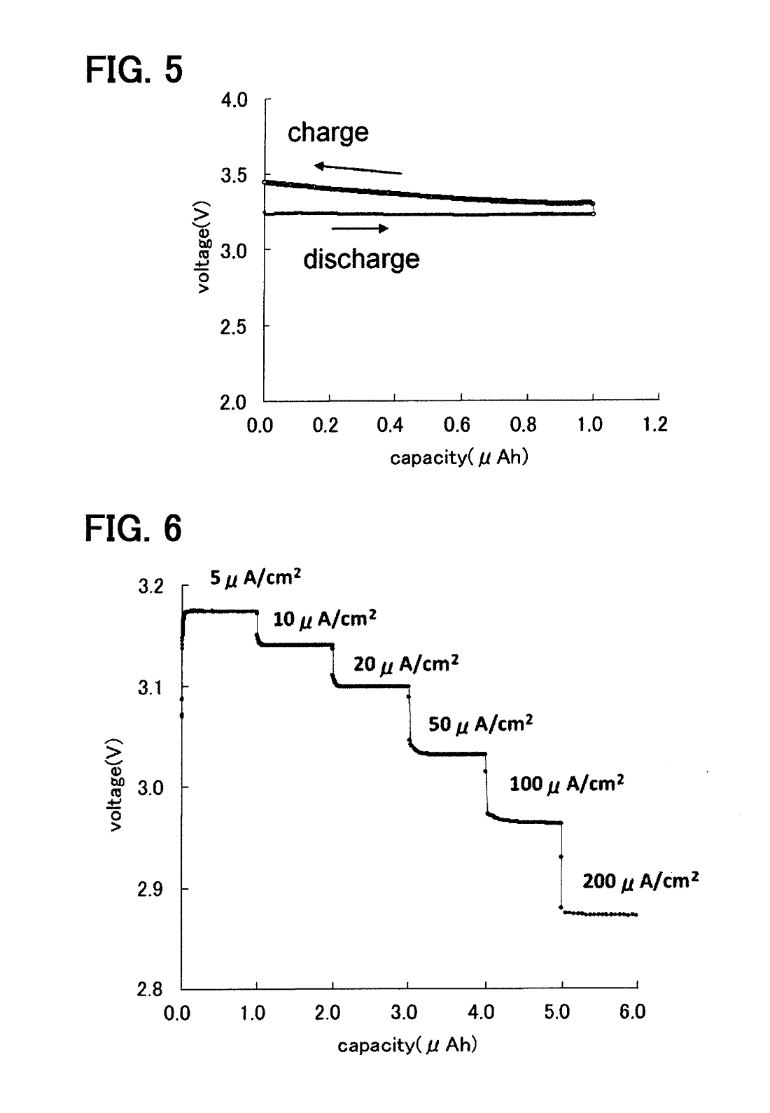

The constant-current constant-voltage discharge and charge (charge after discharge) was performed on each of the air battery systems 1 in the test example and the comparative test example at a voltage ranging from 2.0 to 4.0 V and a current density of 1 ρA/cm². FIG. 4 shows the changes in the voltage of the air battery cell 2 in the test example when discharging and charging. FIG. 5 shows the changes in the voltage of the air battery cell in the comparative test example.

As shown in FIG. 4, it can be confirmed that the air battery system 1 in the test example enables discharging and charging at a capacity of 1.0 μAh. In contrast, as can be seen from FIG. 5, in the comparative test example, in charge after discharge, a voltage of the battery drastically increases halfway through the battery capacity (at a capacity of about 0.6 μAh in FIG. 5) (which means the occurrence of overvoltage). That is, it is found that in the charge after the discharge, the charge capacity of the battery was decreased to about 0.4 μAh.

(Discharge and Charge Tests)

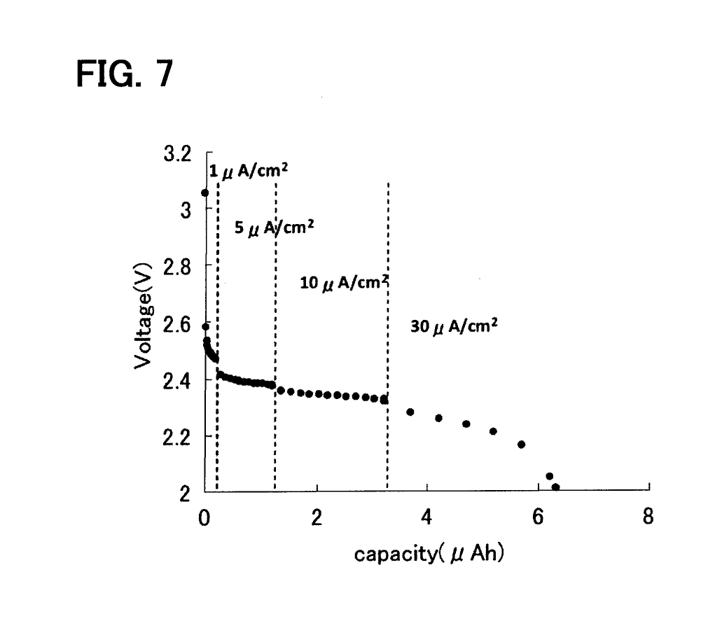

When discharging at current densities of 1, 5, 10, 20, 50, and 100 (μA/cm²), the battery voltages of each air battery cell were measured. FIG. 6 shows the changes in the voltage of the air battery cell 2 in the test example. FIG. 7 shows the changes in the voltage of the air battery cell in the comparative test example.

As shown in FIG. 6, it can be confirmed that the air battery system 1 in the test example enables discharging at a voltage of 2.9 V or higher. In contrast, as shown in FIG. 7, in the comparative test example, the maximum voltage is 2.6 V. That is, it can be confirmed that the overvoltage in the air battery cell 2 of the test example is drastically decreased, compared to that in the comparative test example.

(Cycle Test)

The changes in the voltage of the air battery cell 2 in the test example after repeating six (6) cycles, each cycle including the discharge and charge in the above-mentioned discharge and charge test, were examined. This test corresponds to the repetition of FIG. 4 described above.

It can be confirmed that the air battery cell 2 in the air battery system 1 of the test example exhibits substantially the constant change in the voltage. That is, after the repetition of the discharge and charge, the discharge and charge characteristics of the air battery cell 2 in the test example were not degraded. In contrast, in the comparative test example, as shown in FIG. 5, the voltage (battery capacity) of the air battery cell 2 in charging after the discharge was not recovered to the same level as that before the discharge, and thus the battery cell could not exhibit substantially the same change in the voltage. That is, even after the repetition of the discharge and charge, the discharge and charge characteristics of the air battery cell 2 in the comparative test example were degraded.

As mentioned above, the air battery system 1 in the test example had the air battery cell 2 in the atmosphere with the humidified gas including oxygen. That is, the reduction of oxygen in the air battery cell 2 was promoted in the presence of the vapor-phase water. With this arrangement, the air battery cell 2 can exhibit the effect of reducing the overvoltage during discharge and charge.

Furthermore, in the air battery cell 2 in the test example, the cathode 3 was formed of the same (integrated) solid electrolyte as that of the solid electrolyte layer 5. In short, the reduction in ion conductivity due to the contact resistance at the interface between the cathode 3 and the solid electrolyte layer 5 was suppressed. That is, such an air battery cell 2 enables the discharge and charge with a large amount of current. Consequently, the air battery system 1 in the test example can exhibit the effect of discharging and charging with a large amount of current.

Furthermore, as the cathode 3, the anode 4, and the solid electrolyte layer 5 were respectively made of the solid electrolyte, the all-solid-state air battery cell 2 was formed in which these elements, namely, the cathode, anode, and solid electrolyte layer acted as a supporting member that supported each other. The all-solid-state air battery cell 2 exhibits the effect of suppressing the degradation in performance thereof. Moreover, the electrolyte does not use an organic solvent, which can demonstrate the excellent effect in terms of safety as no combustion occurs.

(Observation of Reaction Products)

The solid electrolyte layer 5 of the air battery cell 2 in the test example obtained after the discharge and charge test was observed. A reaction product at the cathode was observed on the surface of the solid electrolyte layer 5. In observation of the solid electrolyte layer 5, the air battery cell 2 in the test example discharged at a current density of 100 (μA/cm²) for two hours was decomposed to take out the solid electrolyte layer.

(SEM)

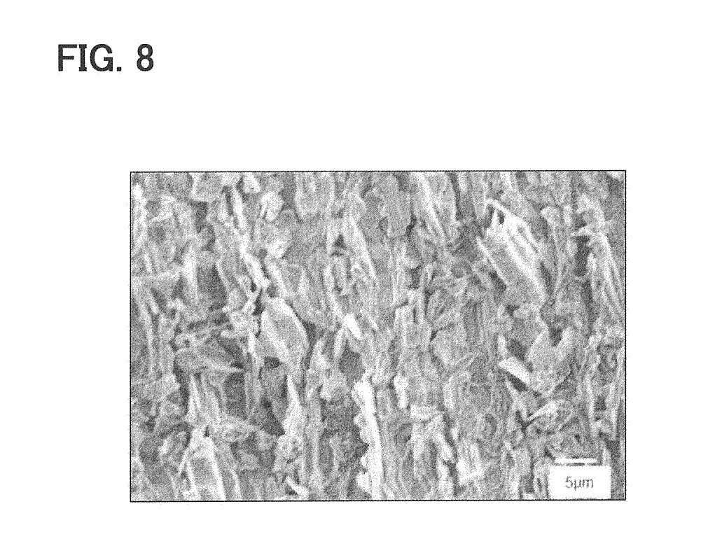

The surface of the solid electrolyte layer 5 abutted against the cathode 3 was observed by the SEM. The image result of the SEM is shown in FIG. 8.

As shown in FIG. 8, it can be confirmed that reaction products generated by the cathode 3 are present at the surface of the solid electrolyte layer 5.

(Raman Spectroscopic Analysis)

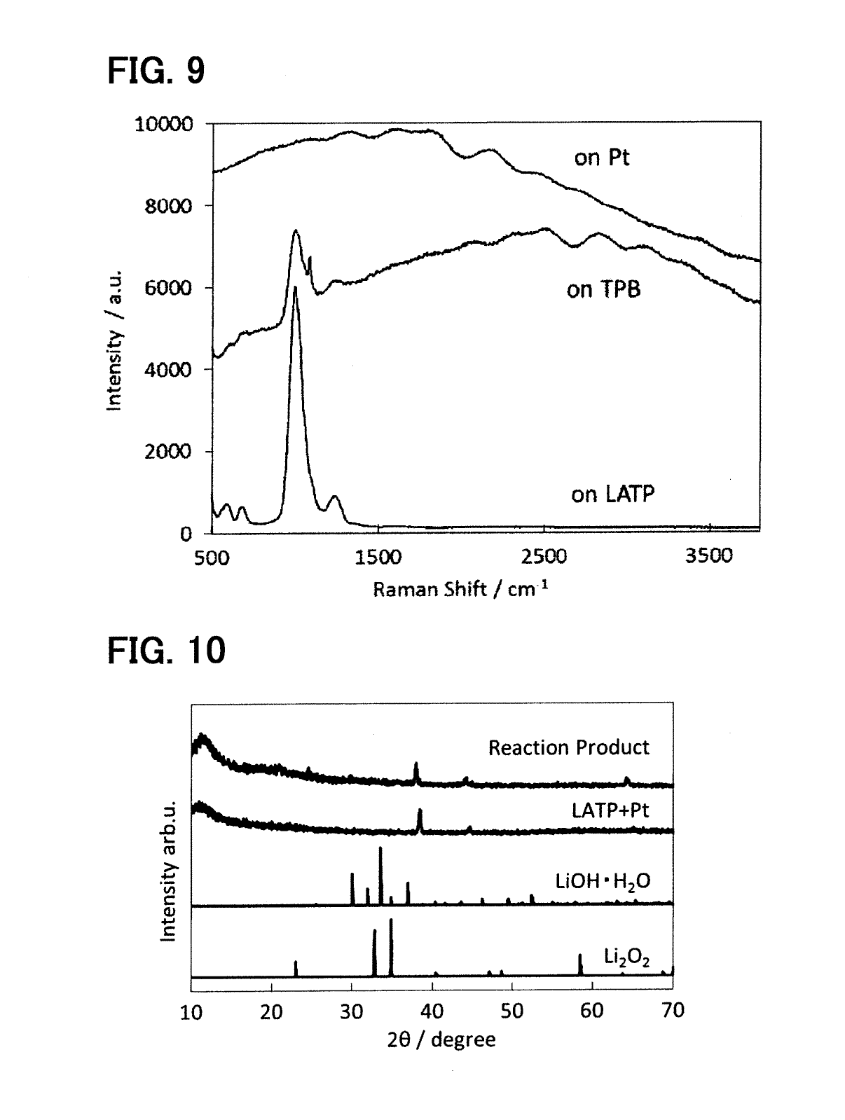

The surface of the solid electrolyte layer 5 was observed by a Raman spectroscopic analysis method. The Raman spectroscopic analysis was performed using a Raman spectrophotometer (manufactured by HORIBA, Ltd., trade name: LabRAM HR-800). The measurement results are shown in FIG. 9.

As shown in FIG. 9, a peak derived from the solid electrolyte of the solid electrolyte layer 5 can be recognized, but no peak due to the reaction product can be observed. This can show that the reaction product at the cathode 3 did not have any crystal structure, that is, the reaction product could be confirmed to be in an amorphous state.

Additionally, since no peak inherent to the reaction product was confirmed, the reaction product could be confirmed to be substantially in the amorphous state. That is, the most majority (90% or more, 90 vol % or more) of the reaction products can be confirmed to be in the amorphous state.

Note that if there exists not amorphous, but crystalline LiOH, a peak will be able to be confirmed at about 2500 (cm⁻¹). Similarly, it could be confirmed that crystalline Li₂O₂ exhibits a peak at about 790 (cm⁻¹), and crystalline Li₂O exhibits a peak at about 515 (cm⁻¹). These lithium compounds are supposed to be produced as chemical reaction compounds.

(XRD)

The surface of the solid electrolyte layer 5 was observed by an XRD method. The XRD was performed using an X-ray diffraction device (manufactured by RIGAKU Corporation, trade name: RINT-2500). The measurement results are shown in FIG. 10.

As shown in FIG. 10, a peak derived from the solid electrolyte of the solid electrolyte layer 5 can be recognized, but no peak due to the reaction product can be observed. This can show that the reaction product at the cathode 3 did not have any crystal structure, that is, the reaction product could be confirmed to be in an amorphous state.

As can be seen from the results of the above-mentioned respective analysis, in the air battery cell 2 of the air battery system 1 in the test example, the reaction product generated by the discharge at the cathode 3 included the amorphous phase. This arrangement can exhibit the effect of enabling charge and discharge with a large amount of current as described above.

Note that in the air battery cell 2 of the air battery system 1 in the test example, the reaction product at the cathode 3 is confirmed to have not an amorphous state but a crystal structure.

(SIMS)

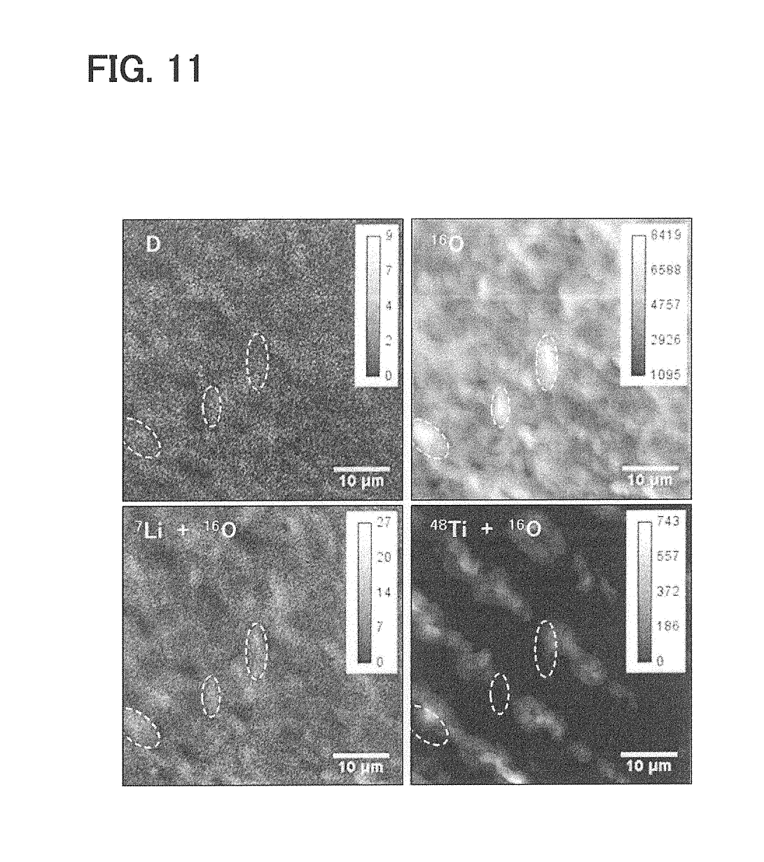

The surface of the solid electrolyte layer 5 was analyzed by a SIMS method. The SIMS method was performed by using a secondary ion mass spectrometer (manufactured by CAMECA SAS, trade name: NANO-SIMS) to execute surface analysis on D (deuterium), O, Li, and Ti. The measurement results are shown in FIG. 11.

The result of the surface analysis on D is shown on the upper left of FIG. 11, from which the existence of D can be recognized in regions enclosed by dashed lines. D is an isotope of hydrogen and substantially shows the existence of atomic hydrogen. That is, the solid electrolyte layer 5 can be confirmed to include hydrogen atoms.

The result of the surface analysis on O is shown on the upper right of FIG. 11, from which the existence of O can be recognized in regions enclosed by dashed lines. That is, the solid electrolyte layer 5 can be confirmed to include oxygen.

The result of the surface analysis on Li is shown on the lower left of FIG. 11, from which the existence of Li can be recognized in regions enclosed by dashed lines. That is, the solid electrolyte layer 5 can be confirmed to include lithium.

The result of the surface analysis on Ti is shown on the lower right of FIG. 11, from which the existence of Ti can be recognized in regions enclosed by dashed lines. That is, the solid electrolyte layer 5 can be confirmed to include Ti.

The respective images shown in FIG. 11 are the results of the surface analysis on the same part of the surface of the solid electrolyte layer 5; the regions enclosed by the dashed lines in the respective images overlap each other. That is, the existence of the reaction products can be recognized in the regions enclosed by the dashed lines. As shown in FIG. 11, the solid electrolyte layer 5 can be confirmed to include hydrogen atoms.

That is, in the air battery cell 2 of the air battery system 1 in the test example, the reaction product generated by the discharge at the cathode 3 includes hydrogen atoms. This arrangement can exhibit the effect of enabling the charge and discharge with a large amount of current as described above.

Note that in the air battery cell 2 of the air battery system 1 in the test example, the reaction product at the cathode 3 has not an amorphous state but the crystal structure, and thus does not include hydrogen atoms.

### Second Embodiment

This embodiment provides substantially the same air battery system 1 as that in the first embodiment except for the structures of the humidification device 6 and the atmosphere adjustment device 8.

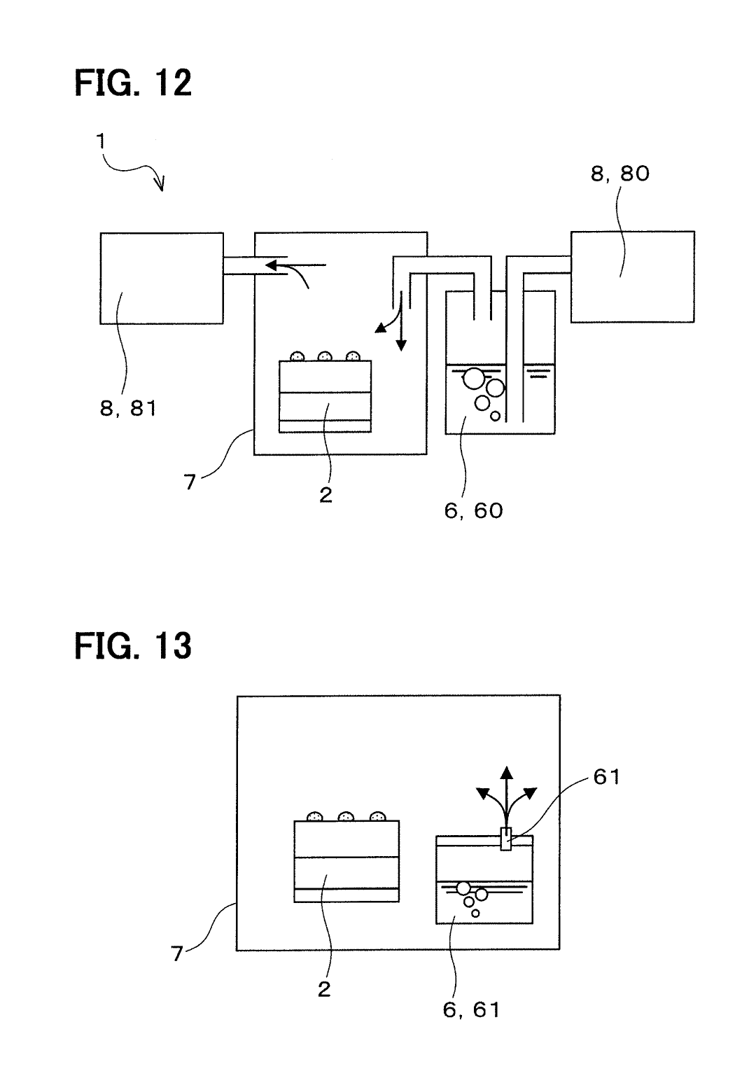

As shown in FIG. 12, in the air battery system 1, the humidification device 6 and the atmosphere adjustment device 8 are formed integrally.

Specifically, a water storing portion 82 is provided for storing therein water in a route (pipe) through which gas flows from the gas supply device 80 of the atmosphere adjustment device 8. The water storing portion 82 is configured to bubble gas in the water stored in the water storing portion 82 and to permit the gas to pass therethrough. In this embodiment, the gas is supplied into the case 7 while being humidified.

This embodiment has substantially the same arrangement as the first embodiment except that the gas is supplied into the case 7 while being humidified, and has substantially the same effects as those in the first embodiment.

In this embodiment, when the gas supplied from the gas supply device 80 includes aqueous impurities, these impurities can also be removed. If the gas supplied from the gas supply device 80 is the air, the aqueous impurities can include components included in the air, such as carbon dioxide.

### Third Embodiment

This embodiment provides substantially the same air battery system 1 as that in the first embodiment except for the structures of the humidification device 6 and the atmosphere adjustment device 8.

As illustrated in FIG. 13, the battery system 1 accommodates the humidification device 6 in the case 7. Further, the battery system 1 does not include the atmosphere adjustment device 8.

The humidification device 6 includes a raw-material storing portion 61 and a humidified-gas supply portion 62.

The raw-material storing portion 61 stores therein a compound including oxygen and water. The compound including oxygen and water stored in the raw-material storing portion 61 is not particularly limited. This embodiment utilizes hydrogen peroxide (liquid-phase hydrogen peroxide). Note that this compound may be an organic or inorganic compound other than hydrogen peroxide.

The humidified-gas supply portion 62 decomposes the compound stored in the raw-material storing portion 61 to supply the generated oxygen and water in a vapor phase into the case 7. The humidified-gas supply portion 62 in this embodiment decomposes the hydrogen peroxide by adding a catalyst thereto. Then, the humidified-gas supply portion 62 supplies the generated oxygen and water in the vapor-phase into the case 7.

The humidified-gas supply portion 62 in this embodiment causes a reaction that decomposes the compound stored in the raw-material storing portion 61 to generate oxygen and water, but preferably can also cause a reverse reaction. During charge, the humidified-gas supply portion 62 enables the reverse reaction, making the air battery system 1 movable in a closed system.

This embodiment has substantially the same arrangement as the first embodiment except that the atmosphere in the case 7 is directly humidified, and has substantially the same effects as those in the first embodiment.

This embodiment does not include the gas supply device 80 and thus exhibits the effect of independently enabling the formation of the battery system 1 in the closed system.

[First Modification]

The air battery cell 2 in each of the above-mentioned embodiments is a single cell structure, but is not limited thereto. The air battery cell 2 may be any stacked air battery that includes a number of cells stacked on each other as long as the battery has the structure to promote the reduction of oxygen in the presence of water.

[Second Modification]

The air battery cell 2 in each of the above-mentioned embodiments has the cathode 3 and the solid electrolyte layer 5 that are integrated together, but is not limited thereto. Alternatively, the anode 4 may also be integrally formed with the cathode and the solid electrolyte layer.

An air battery cell that is manufactured by the following manufacturing method can be specifically exemplified as the air battery cell 2 in this embodiment.

(Manufacturing Method for Air Battery Cell)

In manufacturing the solid electrolyte layer, first, solid electrolyte powder, a binder, and an appropriate dispersion medium are prepared and mixed together to produce a solid electrolyte slurry. Then, a solid electrolyte green sheet is fabricated from the solid electrolyte slurry.

Here, the term “green sheet” as used herein means a non-sintered body that is formed of crystal powder and the like in a thin plate shape. Specifically, the green sheet means a formed body obtained by forming a mixed slurry that includes crystal powder, a conductive material, a binder, a solvent, and the like, through a doctor blade method, calendering, coating methods, such as spin coating and dip coating, printing methods, such as inkjet printing and offset printing, a die coater method, a spray method, or the like.

The binder exhibits the function of mutually bonding and fixing components included in the solid electrolyte. The binder is not particularly limited, but includes thermoplastic resins and thermoset resins. Examples of such resins can include polyethylene, polypropylene, polytetrafluoroethylene (PTFE), polyvinylidene fluoride (PVDF), styrene-butadiene rubber, tetrafluoroethylene-hexafluoroethylene copolymer, tetrafluoroethylene-hexafluoropropylene copolymer (FEP), tetrafluoroethylene-perfluoroalkyl vinyl ether copolymer (PFA), vinylidene fluoride-hexafluoropropylene copolymer, vinylidene fluoride-chlorotrifluoroethylene copolymer, ethylene-tetrafluoroethylene copolymer (ETFE resin), polychlorotrifluoroethylene (PCTFE), vinylidene fluoride-pentafluoropropylene copolymer, propylene-tetrafluoroethylene copolymer, ethylene-chlorotrifluoroethylene copolymer (ECTFE), vinylidene fluoride-hexafluoropropylene-tetrafluoroethylene copolymer, vinylidene fluoride-perfluoromethylvinylether-tetrafluoroethylene copolymer, and ethylene-acrylic acid copolymer. These materials may be used alone or in combination.

The solid electrolyte layer 5 preferably has, at a part thereof, holes for introducing the anode material thereinto. That is, the solid electrolyte green sheet can be classified into a part (solid electrolyte portion) serving as the solid electrolyte layer after the subsequent integral sintering process and a part (anode portion) serving as the anode. The anode portion is disposed on the other end of the solid electrolyte portion opposite to one end thereof on which a cathode green sheet is stacked later.

Alternatively, the anode portion may be separately formed from the solid electrolyte layer green sheet and then integrated with the green sheet.

The anode portion of the solid electrolyte green sheet preferably includes a hole-forming material. As will be described in more detail later, after the cathode green sheet and the anode green sheet are integrally sintered together, holes can be formed in the anode portion by the action of the hole-forming material. Into these holes, a lithium metal liquid is introduced under a predetermined pressure, or Li metal is precipitated through the solid electrolyte, thereby manufacturing the anode.

The hole-forming material forms holes in the anode of a sintered body of the solid electrolyte green sheet. The hole-forming material serves to form the holes for introducing the anode active material thereinto. The hole-forming material is desired to be capable of forming holes by being vaporized through the sintering. Examples of the hole-forming material can include theobromine, graphite, wheat flour, starch, phenol resin, polymethyl methacrylate, polyethylene, polyethylene terephthalate, and foamed resin (acrylonitrile-based plastic balloon, etc.), which are powdery or fibrous materials.

The hole-forming material is preferably used together with the conductive material. Because of this, the anode portion can form therein holes that include the conductive material after sintering.

In manufacturing the cathode, first, catalyst powder, hole-forming material powder, conductive material powder, a binder, and an appropriate dispersion medium are prepared and mixed together to produce a cathode slurry. Then, a cathode green sheet is fabricated from the cathode slurry.

The hole-forming material powder is to form holes for introducing oxygen into the cathode material. The hole-forming material is desired to be capable of forming holes by being vaporized through the sintering. The hole-forming material preferably utilizes the same material as the above-mentioned hole-forming material.

When forming the solid electrolyte green sheet, the cathode green sheet, and the anode portion thus fabricated as different sheets, the anode green sheet is stacked to thereby form a stacked body. At this time, the cathode green sheet is stacked on one end of the solid electrolyte sheet opposed to the other end (anode portion) of the solid electrolyte green sheet including the hole-forming material. The stacked body fabricated in these ways are sintered integrally.

In the sintering step, the type of atmosphere is not limited. However, the sintering step is preferably performed under a condition in which a valence of a transition metal included in the electrode active material does not change. More preferably, the sintering step is performed in an oxygen atmosphere, particularly, in the air atmosphere. The sintering needs only to reduce the contact resistances between the cathode and the solid electrolyte and between the anode and the solid electrolyte. The sintering temperature in use of an inorganic solid electrolyte is set, for example, at 600 to 1100° C.

In the way described above, the solid electrolyte green sheet and the cathode green sheet are bonded (sintered) to be integrated with each other. That is, the solid electrolyte in the cathode 3 and the solid electrolyte layer 5 are bonded and integrated.

After integrally sintering the stacked body of the green sheets, holes are formed in a part (the other end) of the sintered body corresponding to the anode portion. Into these holes, a lithium metal liquid is introduced under a predetermined pressure to form the anode 4. Alternatively, a lithium metal may be electrodeposited in the holes by charging and discharging.

In the way described above, a charge-discharge element in which the cathode 3, the solid electrolyte layer 5, and the anode 4 are integrally formed is manufactured.

Also in this embodiment, the cathode 3 and the solid electrolyte layer 5 have the same solid electrolyte as the base material. Thus, the reduction in the ion conductivity due to the contact resistance at the interface between the cathode 3 and the solid electrolyte layer 5 was suppressed. That is, the same effects as those described in the above respective embodiments can be exhibited.

Note that the anode 4 may be formed by fabricating an anode green sheet and integrally sintering the green sheet together with the solid electrolyte portion, in the same way as the cathode 3. Here, the solid electrolyte layer is not provided with an anode portion. In this case, the anode green sheet can be fabricated in the same way as the cathode green sheet.

Then, the cathode green sheet, the solid electrolyte green sheet, and the anode green sheet are stacked in this order to form the stacked body, which is then sintered integrally.

In this arrangement, the cathode 3, the solid electrolyte layer 5, and the anode 4 use the same solid electrolyte as their base materials. The same effect as that at the interface between the above-mentioned cathode 3 and solid electrolyte layer 5 is also exhibited at the interface between the solid electrolyte layer 5 and the anode 4. That is, the air battery system 1 (and the air battery cell 2) in the test example can exhibit the effect of enabling the charge and discharge with a large amount of current.

The present disclosure includes the following aspects.

Accordingly, it is an object of the present disclosure to provide a lithium-air battery and a lithium-air battery device that enables the charge and discharge with a large amount of current while being capable of suppressing the occurrence of overvoltage.

A lithium-air battery according to a first aspect of the present disclosure includes: an anode that includes an anode material capable of absorbing and desorbing a lithium ion; a cathode that includes a cathode material using oxygen as a cathode active material and including a catalyst to reduce the oxygen; and a solid electrolyte layer that includes a solid electrolyte interposed between the anode and the cathode. At least one of charge and discharge is performed in the presence of vapor-phase water. That is, the reduction of oxygen or an oxide is performed in the presence of the vapor-phase water. With this arrangement, the air battery can exhibit the effect of reducing the overvoltage.

A lithium-air battery according to a second aspect of the present disclosure includes: an anode that includes an anode material capable of absorbing and desorbing a lithium ion; a cathode that includes a cathode material using oxygen as a cathode active material and including a catalyst to reduce the oxygen; and a solid electrolyte layer that includes a solid electrolyte interposed between the anode and the cathode. A reaction product generated by discharge includes an amorphous phase. That is, the reaction product generated by the discharge includes the amorphous phase, thereby exhibiting the same effects as those of the first air battery described above.

A lithium-air battery according to a third aspect of the present disclosure includes: an anode that includes an anode material capable of absorbing and desorbing a lithium ion; a cathode that includes a cathode material using oxygen as a cathode active material and including a catalyst to reduce the oxygen; and a solid electrolyte layer that includes a solid electrolyte interposed between the anode and the cathode. A reaction product generated by discharge includes hydrogen atoms. That is, the reaction product generated by the discharge includes hydrogen atoms, thereby exhibiting the same effects as those of the first and second air batteries described above. Note that the hydrogen atom in the reaction product means hydrogen in an atomic state. The hydrogen in the atomic state includes hydrogen in a proton (an ionic) state.

A lithium-air battery device according to a fourth aspect of the present disclosure includes: a lithium-air battery cell including an anode that includes an anode material capable of absorbing and desorbing a lithium ion, a cathode that includes a cathode material using oxygen as a cathode active material and including a catalyst to reduce the oxygen, and a solid electrolyte layer that includes a solid electrolyte interposed between the anode and the cathode; and a water supply portion that supplies vapor-phase water to the cathode of the lithium-air battery cell. The lithium-air battery device can exhibit the same effects as those of the first to third air batteries in the present invention described above.

Alternatively, the water supply portion may be a humidification device that humidifies gas including oxygen. In this case, the humidification device can be provided to supply oxygen as the cathode active material to the cathode of the air battery cell in the presence of vapor-phase water, so that the reduction of oxygen can be performed in the presence of the water.

Alternatively, the water supply portion may decompose a compound including oxygen and water, and also supply the generated oxygen and water in the vapor phase. With this arrangement, oxygen as the cathode active material can be supplied to the cathode of the air battery cell in the presence of the vapor-phase water, so that the reduction of oxygen can be performed in the presence of the water.

Alternatively, at least one of the cathode material and the anode material may include the solid electrolyte and may be bonded with the solid electrolyte layer while having an interface with the solid electrolyte layer. With this arrangement, at least one of the cathode (generally referred to as an air electrode) and the anode is bonded to the solid electrolyte layer. Thus, the battery cell can be configured to cause at least one of the cathode, the anode, and the solid electrolyte layer to serve as a supporter.

Alternatively, in the lithium-air battery cell, at least one of the solid electrolyte layer, the anode, and the cathode may serve as a supporter that supports at least one of the remainder thereof. The cathode, the anode, and the solid electrolyte layer may be supporters that are supported by one another. This arrangement makes it possible to form the whole air battery cell by solid materials (all-solid-state air battery cell). The all-solid-state air battery cell can hold the respective components (for example, not to cause the flow of the electrolyte), thereby suppressing the degradation in the performance thereof. Moreover, the all-solid-state air battery cell does not use an organic solvent in the electrolyte and the like, and thus is superior in safety as no combustion occurs.

Alternatively, at least one of the cathode and the anode and the solid electrolyte layer may be integrally bonded together by sintering to form a sintered body. With this arrangement, at least one of the cathode and the anode and the solid electrolyte layer forms the sintered body by being integrated by sintering, which can suppress the reduction in the ion conductivity due to the contact resistance at the interface therebetween.

Alternatively, the solid electrolyte may include at least one inorganic solid electrolytic material selected from the group consisting of a perovskite-type, a NASICON-type, a LISICON-type, a thio-LISICON type, a γ-Li₃PO₄-type, a garnet-type, and a LIPON-type electrolytic materials. With this arrangement, the cathode (air electrode) included in the air battery device of the present invention does not include an organic solvent, and thus can suppress the degradation in the performance of the battery due to the volatilization of the organic solvent.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A lithium-air battery comprising:
an anode that includes an anode material for absorbing and desorbing a lithium ion;
a cathode that includes a cathode material with a catalyst for reducing the oxygen using oxygen as a cathode active material; and
a solid electrolyte layer that includes a solid electrolyte interposed between the anode and the cathode, wherein:
at least one of charge and discharge is performed in a presence of vapor-phase water.

2. A lithium-air battery comprising:
an anode that includes an anode material for absorbing and desorbing a lithium ion;
a cathode that includes a cathode material with a catalyst for reducing the oxygen using oxygen as a cathode active material; and
a solid electrolyte layer that includes a solid electrolyte interposed between the anode and the cathode, wherein:
a reaction product generated by discharge includes an amorphous phase.

3. The lithium-air battery according to claim 2, wherein:
90% or more of the reaction product includes the amorphous phase.

4. A lithium-air battery comprising:
an anode that includes an anode material for absorbing and desorbing a lithium ion;
a cathode that includes a cathode material with a catalyst for reducing the oxygen using oxygen as a cathode active material; and
a solid electrolyte layer that includes a solid electrolyte interposed between the anode and the cathode, wherein:
a reaction product generated by discharge includes a hydrogen atom.

5. A lithium-air battery device comprising:
a lithium-air battery cell including an anode that includes an anode material for absorbing and desorbing a lithium ion, a cathode that includes a cathode material with a catalyst for reducing the oxygen using oxygen as a cathode active material, and a solid electrolyte layer that includes a solid electrolyte interposed between the anode and the cathode; and
a water supply unit that supplies vapor-phase water to the cathode of the lithium-air battery cell.

6. The lithium-air battery device according to claim 5, wherein:
the water supply unit is a humidifying device that humidifies gas including oxygen.

7. The lithium-air battery device according to claim 5, wherein:
the water supply unit decomposes a compound having oxygen and water, and supplies generated oxygen and water in a vapor phase.

8. The lithium-air battery device according to claim 5, wherein:
at least one of the cathode material and the anode material includes the solid electrolyte, and is bonded with the solid electrolyte layer via an interface.

9. The lithium-air battery device according to claim 5, wherein:
at least one of the cathode and the anode, and the solid electrolyte layer provide a sintered body integrated into one body by sintering.

10. The lithium-air battery device according to claim 5, wherein:
the solid electrolyte includes at least one inorganic solid electrolytic material selected from the group consisting of a perovskite-type electrolytic material, a NASICON-type electrolytic material, a LISICON-type electrolytic material, a thio-LISICON type electrolytic material, a γ-Li₃PO₄-type electrolytic material, a garnet-type electrolytic material, and a LIPON-type electrolytic material.

11. The lithium-air battery device according to claim 5, wherein:
in the lithium-air battery cell, at least one of the solid electrolyte layer, the anode, and the cathode provides a supporter that supports at least one of the other of the solid electrolyte layer, the anode, and the cathode.
